(19) United States
(12) Patent Application Publication
(10) Pub. No.: US 2019/0084505 A1
(43) Pub. Date: Mar. 21, 2019

(54) CONDUCTOR CONNECTION STRUCTURE FOR ROUTING MEMBERS

(71) Applicant: YAZAKI CORPORATION, Tokyo (JP)

(72) Inventors: Masahito Ozaki, Shizuoka (JP); Goro Nakamura, Shizuoka (JP)

(21) Appl. No.: 16/135,922

(22) Filed: Sep. 19, 2018

(30) Foreign Application Priority Data
Sep. 20, 2017 (JP) 2017-180345

(51) Int. Cl. B60R 16/02; H01R 4/02; H01R 4/58; H01R 13/621

(52) U.S. Cl. CPC B60R 16/0215; H01R 13/621; H01R 4/58; H01R 4/029

(57) ABSTRACT

A conductor connection structure for routing members includes a routing member in which an outer circumferential surface of a long conductor except conductor end face portions of both ends in a longitudinal direction is coated and insulated, and a junction member having a plurality of junction end face portions and made of a conductive metal. One of the junction end face portions is metallurgically bonded to one of the conductor end face portions.

### CROSS REFERENCE TO RELATED APPLICATIONS

This application claims priority from Japanese Patent Application No. 2017-180345 filed on Sep. 20, 2017, the entire contents of which are incorporated herein by reference.

### BACKGROUND OF THE INVENTION

### Field of the Invention

The present invention relates to a conductor connection structure for routing members

### Description of Related Art

In a related art, when a long routing member is connected to a connection target, a through-hole for bolt connection is generally formed in a terminal. In addition, branch lines for a trunk line of a wire harness are branched off using a box or a connector to distribute and supply received power.

### [Patent Literature 1] JP-A-2011-113928

### [Patent Literature 2] JP-A-2017-19328

However, in a connection structure in a related art, a through-hole for connection using a bolt or the like needs to be provided in the cable terminal. Forming a bolt fastening hole in a terminal of a long cable leads to a problem that workability is bad and dimensional accuracy is not easily secured. In a wire harness of a related art, the branch lines for the trunk line are connected using the box or the connector. For this reason, there is a need to dispose a bus bar circuit in the box or prepare a connector for connection, and the number of components is increased. A space for installing the box is also required.

### SUMMARY

One or more embodiments provide a conductor connection structure for routing members preventing an increase in the number of components and coping with a plurality of branching forms with a saved space while securing dimensional accuracy with easy machining work.

In an aspect (1), one or more embodiments provide a conductor connection structure for routing members including a routing member in which an outer circumferential surface of a long conductor except conductor end face portions of both ends in a longitudinal direction is coated and insulated, and a junction member having a plurality of junction end face portions and made of a conductive metal. One of the junction end face portions is metallurgically bonded to one of the conductor end face portions.

According to the aspect (1), the junction end face portions of the junction member formed of a conductive metal are metallurgically bonded to the conductor end face portions of the long routing members. The bonding is performed by, for instance, friction stir welding or welding. Since both base materials of the conductor end face portion and the junction end face portion are metallurgically bonded, high-strength junction can be achieved. The work of coupling the junction end face portion of the junction member to the conductor end face portion of the long conductor through friction stir welding or welding is possible with less handling of the long conductor, compared to the case in which the bolt fastening hole is directly machined in the long conductor. Thus, according to the conductor connection structure for routing members having the above configuration, workability to connect the long routing members to connection targets and machining accuracy can be remarkably improved. Since the conductor end face portions of the long conductors in the plurality of routing members can be directly connected to the junction end face portions of the junction member that has been machined in advance by metallurgically bonding, a box or a connector for connecting the plurality of routing members is not required, and the number of components can be prevented from increasing. Further, a routing space can also be reduced compared to a case in which the box or the connector is used. In addition to this configuration, since the junction end face portions can be formed in an arbitrary number, the junction member can cope with various branching forms using the plurality of routing members.

In an aspect (2), the routing member is formed in a plate shape and the junction member is formed in a plate shape.

According to the aspect (2), since the routing member is formed in a plate shape and the junction member is formed in a plate shape in addition to the fact that the box or the connector is not required, a routing height can be suppressed while securing a cross-sectional area (that is, an energization cross-sectional area) perpendicular to a longitudinal direction of the long conductor. Thereby, a routing space for the routing members can be further reduced.

In an aspect (3), a fastening piece in which a bolt fastening hole is drilled is projected from at least one of the junction end face portions of the junction member.

According to the aspect (3), the fastening piece including the fastening hole is projected from the junction end face portion of the junction member. The junction member includes a plurality of junction end face portions. Thus, in the case of the junction members including, for instance, three junction end face portions, two junction end face portions and one fastening piece are provided. In the case of the junction member including, for instance, two junction end face portions, one junction end face portion and one fastening piece are provided. This junction member is attached to the conductor end face portions of the long routing members by metallurgically bonding the junction end face portions of the junction member. That is, the long routing body in which the fastening piece is provided at an end of the routing member can be formed. Since the routing body on which the fastening piece is provided does not need to directly machine the bolt fastening hole in the end of the long routing member as in the related art, a highly accurate bolt fastening hole can be easily obtained.

In an aspect (4), the fastening piece is projected from each of a plurality of the junction members. The plurality of the junction members are bolt-nut fastened at the fastening pieces.

According to the aspect (4), the fastening piece of the junction member in the other routing body (for instance, a branch line) can be bolt-nut fastened to the routing body (for instance, a trunk line) made up of the plurality of routing members connected via the junction member using the fastening piece provided on the junction member. Thereby, without using the box or the connector, the branch line can be simply connected to the trunk line in a branching form with a saved space and a small number of components.

In an aspect (5), the junction member is formed in a polygonal plate shape.

According to the aspect (5), in the plate-like routing members and the plate-like junction member in which a routing height is suppressed, the plurality of routing members can be connected in a branching form in an intersecting direction, or be connected in multiple directions, thereby improving a degree of freedom of a routing design.

In an aspect (6), a junction routing body in which the conductor end face portions of a plurality of the routing members are respectively metallurgically bonded to a plurality of the junction end face portions of the junction member is formed. A stacked junction routing body in which a plurality of the junction routing bodies are stacked is formed.

According to the aspect (6), since the plurality of junction routing bodies formed by the plate-like routing members and the plate-like junction member are stacked to constitute the stacked junction routing body, the number of circuits can be multiplied while suppressing a routing height (a height in a plate thickness direction).

The conductor connection structure for routing members according to the present invention can suppress the number of components and cope with a plurality of branching forms with a saved space while securing dimensional accuracy with easy machining work.

One or more embodiments has been briefly described. Further, modes described below are read through with reference to the attached drawings, and thereby details of the present invention will be further clarified.

### BRIEF DESCRIPTION OF THE DRAWINGS

FIG. 1 is an assembled perspective view illustrating a bolt-nut fastened state of a junction routing body and a routing body that are coupled with a conductor connection structure for routing members according to a first embodiment of the present invention;

FIG. 2 is an exploded perspective view of the junction routing body and the routing body illustrated in FIG. 1;

FIG. 3A is an exploded perspective view of the junction routing body in which the two routing members are coupled in series, and FIG. 3B is an assembled perspective view of the junction routing body illustrated in FIG. 3A;

FIG. 4A is an exploded perspective view of the routing body in which the junction member including a fastening piece projected from a junction end face portion is connected to the conductor end face portion of the routing member, and FIG. 4B is an assembled perspective view of the routing body illustrated in FIG. 4A;

FIG. 5A is an exploded perspective view of a junction routing body according to a modification, and FIG. 5B is an assembled perspective view of the junction routing body illustrated in FIG. 5A;

FIG. 6A is an exploded perspective view of a multidirectionally-junction routing body coupled with a conductor connection structure for routing members according to a second embodiment of the invention, and FIG. 6B is an assembled perspective view of the multidirectionally-junction routing body illustrated in FIG. 6A;

FIG. 7 is an exploded perspective view of a stacked junction routing body formed with a conductor connection structure for routing members according to a third embodiment of the invention; and

FIG. 8 is an assembled perspective view of the stacked junction routing body illustrated in FIG. 7.

### DETAILED DESCRIPTION

Hereinafter, embodiments according to the present invention will be described with reference to the drawings.

### First Embodiment

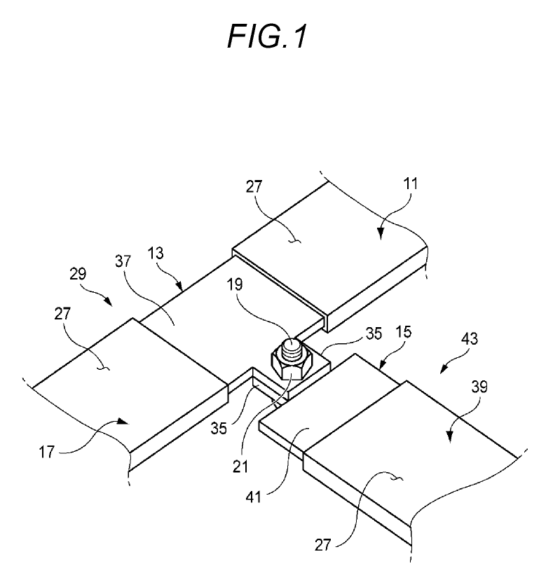

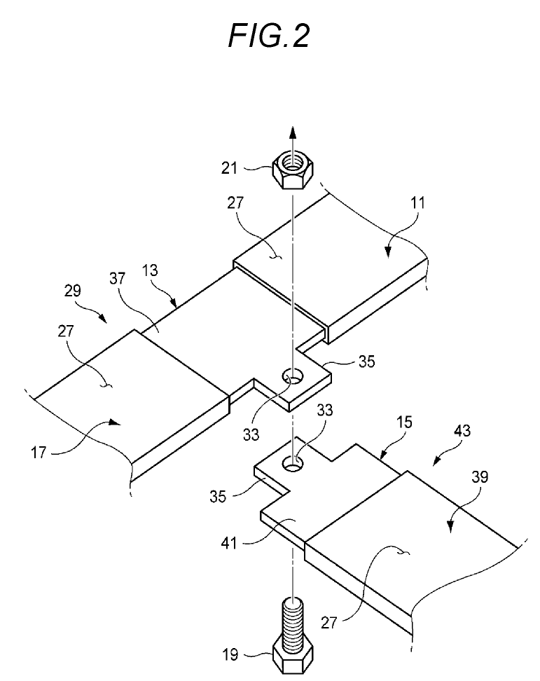

FIG. 1 is an assembled perspective view illustrating a bolt-nut fastened state of a junction routing body 29 and a routing body 43 that are coupled with a conductor connection structure for routing members according to a first embodiment of the invention, and FIG. 2 is an exploded perspective view of the junction routing body 29 and the routing body 43 illustrated in FIG. 1.

As illustrated in FIG. 1, a junction routing body 29 coupled with a conductor connection structure for routing members according to a first embodiment includes routing members 11 and 17 and a junction member 13 as main components. A routing body 43 with the conductor connection structure for routing members according to the first embodiment includes a routing member 39 and a junction member 15 as main components. The junction routing body 29 and the routing body 43 are coupled by a bolt 19 and a nut 21.

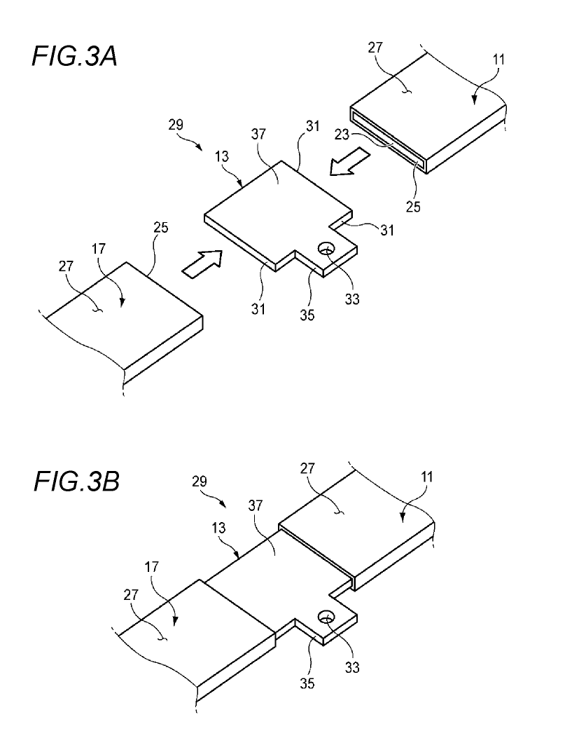

These routing members 11, 17 and 39 are formed in the same structure, and an outer circumferential surface of the long conductor 23 (see FIGS. 3A and 3B) except conductor end face portions 25 of opposite ends of the long conductor 23 in a longitudinal direction is coated and insulated with an insulating layer 27.

In the conductor connection structure for routing members according to the first embodiment, the routing members 11, 17 and 39 are formed in a plate shape.

The routing members 11, 17 and 39 are formed in a long belt plate shape, and have a rectangular cross section perpendicular to a longitudinal direction. In the routing members 11, 17 and 39, a direction perpendicular to a longitudinal direction is a width direction, and a stacking direction is a thickness direction. The routing members 11, 17 and 39 are formed such that a thickness is smaller than a width dimension.

The long conductor 23 is formed of, for example, copper, a copper alloy, aluminum, an aluminum alloy, or the like which is a conductive material.

Since the long conductor 23 is coated and insulated with the insulating layer 27, when each of the routing members 11, 17 and 39 is stacked in a plate thickness direction, a boundary between the stacked routing members is electrically insulated by the insulating layer 27 interposed between the routing members.

As long as the insulating layer 27 electrically insulates the long conductor 23, an arbitrary layer can be used as the insulating layer 27. The insulating layer 27 may be formed on at least one of front and back surfaces of the long conductor 23 by powder coating. As described above, the outer circumferential surface of the long conductor 23 of the present embodiment except the conductor end face portions 25 of the opposite ends in the longitudinal direction is coated and insulated with the insulating layer 27. The powder coating mainly includes two methods of “electrostatic coating (spray coating)” and “fluidized bed coating (dip coating).” The insulating layer 27 may be formed by any of these powder coatings. When the insulating layer 27 is formed by the powder coating, the routing members 11, 17 and 39 are machined by cutting them at a predetermined length after the insulating layer 27 is provided, or by joining the junction members 13 and 15.

In addition, the long conductors 23 of the routing members 11, 17 and 39 may be electrically insulated by a sheet material (an insulating sheet) having electrical insulation properties. In this case, the insulating sheets and the long conductors 23 can be alternately stacked in the routing members 11, 17 and 39. The routing members 11, 17, and 39 in which the insulating sheet is previously stuck on the outer circumferential surface or the front and back surfaces of the long conductor 23 may be used. The long conductor 23 having the insulating sheet stuck on the outer circumferential surface thereof has a structure in which the conductor end face portions 25 thereof are exposed to the opposite ends thereof alone in the longitudinal direction.

FIG. 3A is an exploded perspective view of the junction routing body 29 in which the two routing members 11 and 17 are coupled in series, and FIG. 3B is an assembled perspective view of the junction routing body 29 illustrated in FIG. 3A.

The junction member 13 is formed of a conductive metal that is the same conductive material as the long conductor 23 such as copper, a copper alloy, aluminum, an aluminum alloy, or the like. The insulating layer 27 is not provided on an outer circumferential surface of the junction member 13. The junction member 13 includes a plurality of junction end face portions 31. The junction member 13 can be formed in an arbitrary polygonal plate shape. As illustrated in FIGS. 3A and 3B, the junction member 13 is formed in a quadrilateral plate shape. The plurality of junction end face portions 31 that are metallurgically bonded to the conductor end face portions 25 of the routing members 11 and 17 are formed at the junction member 13.

As illustrated in FIG. 3A, a fastening piece 35 in which a bolt fastening hole 33 is drilled is projected from at least one of the junction end face portions 31 of the junction member 13. That is, the junction member 13 includes the fastening piece 35 projected from one of the three junction end face portions 31 (the junction end face portion 31 at a right oblique lower side in FIGS. 3A and 3B). The junction end face portions 31 and the fastening piece 35 according to the conductor connection structure for routing members of the first embodiment are not limited to this number and arrangement.

The junction end face portions 31 of the junction member 13 and the conductor end face portions 25 of the routing members 11 and 17 are metallurgically bonded by, for instance, friction stir welding. In addition, the junction end face portions 31 and the conductor end face portions 25 may be metallurgically bonded by welding such as resistance welding or ultrasonic welding. In the first embodiment, one opposite sides of a rectangular portion 37 in the junction member 13 formed in the quadrilateral shape are the pair of junction end face portions 31 and 31. The fastening piece 35 is formed by protruding from the junction end face portion 31 at one of the other opposite sides of the rectangular portion 37.

Therefore, as illustrated in FIG. 3B, the junction end face portions 31 and 31 at the one opposite sides of the rectangular portion 37 are metallurgically bonded to the conductor end face portions 25 of the routing members 11 and 17, and thereby the junction member 13 forms the junction routing body 29.

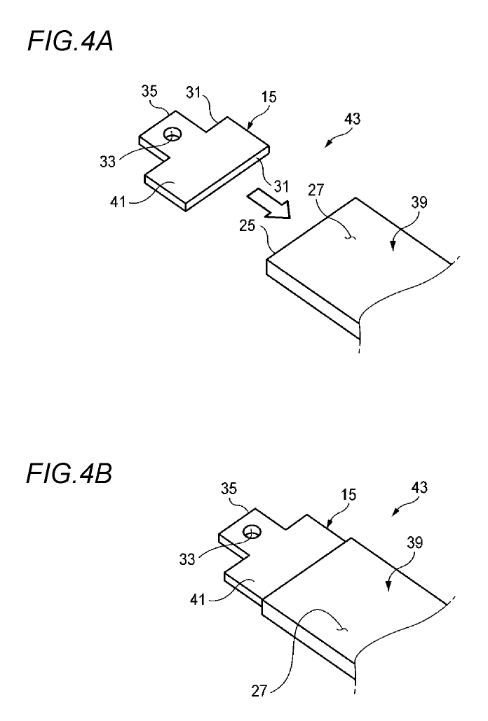

FIG. 4A is an exploded perspective view of the routing body 43 in which the junction member 15 including a fastening piece 35 projected from a junction end face portion 31 is connected to the conductor end face portion 25 of the routing member 39, and FIG. 4B is an assembled perspective view of the routing body 43 illustrated in FIG. 4A.

As illustrated in FIG. 4A, in the junction member 15 formed of a conductive metal, one of one opposite sides of a rectangular portion 41 is a junction end face portion 31, and a fastening piece 35 is projected from the other side.

Therefore, as illustrated in FIG. 4B, junction end face portion 31 located on a side opposite to the fastening piece 35 is metallurgically bonded to the conductor end face portion 25 of the routing member 39, and thereby the junction member 15 forms the routing body 43.

In this way, according to the conductor connection structure for routing members of the first embodiment, the routing member 11 and the routing member 17 can be coupled via the junction member 13 in a linear shape. The fastening piece 35 provided on the routing member 39 can be bolt-nut-fastened to the fastening piece 35 provided on the junction member 13. Thereby, the routing body 43 (for instance, a branch line) made up of the other routing member 39 to which the junction member 15 is connected can be connected to the junction routing body 29 (for instance, a trunk line), which is the routing body made up of the plurality of routing members 11 and 17 connected via the junction member 13, in a branching form in an orthogonal direction.

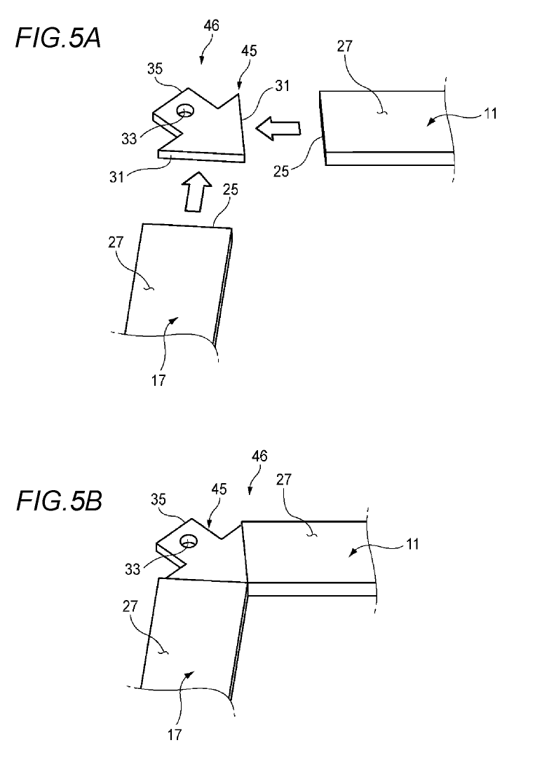

FIG. 5A is an exploded perspective view of a junction routing body 46 according to a modification, and FIG. 5B is an assembled perspective view of the junction routing body 46 illustrated in FIG. 5A.

As illustrated in FIG. 5A, the junction member 45 can be formed in a triangular plate shape. The triangular shape can be, for instance, an equilateral-triangular shape as in the present modification. The triangular shape of the junction member 45 is not limited to the equilateral-triangular shape. In the triangular plate-like junction member 45, two sides become the junction end face portions 31, and the fastening piece 35 is projected from the other side.

For example, the conductor end face portion 25 of the routing member 11 and the conductor end face portion 25 of the routing member 17 are metallurgically bonded to the junction end face portions 31 of the two sides of the junction member 45, thereby forming the junction routing body 46. For example, the routing body 43 is connected to the fastening piece 35 of the other side of the junction member 45 in a branching form by bolt-nut fastening (not shown).

According to the junction routing body 46, branching directions of the three routing members 11, 17 and 39 can be mutually set to, for instance, the directions of 60°. That is, the junction routing body 46 is suitable when the branching directions are unfavorable in orthogonal directions.

In this way, in the junction routing bodies 29 and 46 and the routing body 43 that are coupled with the conductor connection structure for routing members according to the first embodiment, the junction members 13, 15 and 45 based on the branching form are appropriately selected, and thereby the wire harness can be configured with required minimum components.

Next, an operation of the aforementioned configuration will be described.

According to the conductor connection structure for routing members of the first embodiment, the junction end face portion 31 of the junction member 13 formed of a conductive metal are metallurgically bonded to the conductor end face portion 25 of the long routing member 11. The metallic bonding is performed by, for instance, friction stir welding or welding. Since matrixes of the conductor end face portion 25 and the junction end face portion 31 are metallurgically bonded, high-strength bonding is possible.

Work of coupling the junction end face portions 31 of the junction members 13, 15 and 45 to the conductor end face portions 25 of the long conductor 23 through friction stir welding or welding is possible with less handling of the long conductor 23, compared to the case in which the bolt fastening hole 33 is directly machined in the long conductor 23. Thus, according to the conductor connection structure for routing members of the first embodiment, workability to connect the long routing members 11, 17 and 39 to targets to be connected and machining accuracy can be remarkably improved.

In the conductor connection structure for routing members according to the first embodiment, since the conductor end face portions 25 of the long conductors 23 in the plurality of routing members 11, 17 and 39 can be directly connected to the junction end face portions 31 of the junction members 13, 15 and 45 that have been machined in advance by metallic bonding, a box or a connector for connecting the plurality of routing members 11, 17 and 39 is not required, and the number of components can be suppressed.

Further, according to the conductor connection structure for routing members of the first embodiment, in comparison with the case in which the box or the connector is used, a routing space can be reduced. In addition to this configuration, in the conductor connection structure for routing members according to the first embodiment, since the junction end face portions 31 can be formed in an arbitrary number like the aforementioned junction members 13, 15 and 45, these various junction members 13, 15 and 45 can be prepared as common element members of various harness modules.

According to the conductor connection structure for routing members of the first embodiment, since the routing members 11, 17 and 39 and the junction members 13, 15 and 45 are formed in a plate shape in addition to the fact that the box or the connector is not required, a routing height can be suppressed while securing a cross-sectional area (that is, an energization cross-sectional area) perpendicular to the longitudinal direction of the long conductor 23. Thereby, a routing space for the routing members 11, 17 and 39 can be further reduced.

In the conductor connection structure for routing members according to the first embodiment, the fastening piece 35 including the fastening hole 33 is projected from the junction end face portions 31 of the junction members 13, 15 and 45. The junction members 13, 15 and 45 include the plurality of junction end face portions 31. Thus, in the case of the junction members 13 and 45 including three junction end face portions 31, two junction end face portions 31 and one fastening piece 35 are configured to be provided. In the case of the junction member 15 including two junction end face portions 31, one junction end face portion 31 and one fastening piece 35 are configured to be provided. These junction members 13, 15 and 45 are attached to the conductor end face portions 25 of the long routing members 11, 17 and 39 by metallurgically bonding the junction end face portions 31 of the junction member 13. That is, the long junction routing bodies 29 and 46 in which the fastening piece 35 is provided between the routing member 11 and the routing member 17, and the long routing body 43 in which the fastening piece 35 is provided at an end of the routing member 39 can be configured. For example, the routing body 43 on which the fastening piece 35 is provided does not need to directly machine the bolt fastening hole 33 in the end of the long routing member as in the related art. For this reason, a highly accurate bolt fastening hole 33 can be easily obtained.

Further, in the conductor connection structure for routing members according to the first embodiment, the fastening piece 35 of the junction member 15 in the other routing body 43 (for instance, a branch line) can be bolt-nut fastened to the junction routing member 29 (for instance, a trunk line) made up of the routing members 11 and 17 connected via the junction member 13 using the fastening piece 35 provided on the junction member 13 of the junction routing body 29. Thereby, without using the box or the connector, the routing body 43 that is the branch line can be simply connected to the junction routing body 29 that is the trunk line in a branching form with a saved space and a small number of components.

### Second Embodiment

Next, a conductor connection structure for routing members according to a second embodiment of the present invention will be described.

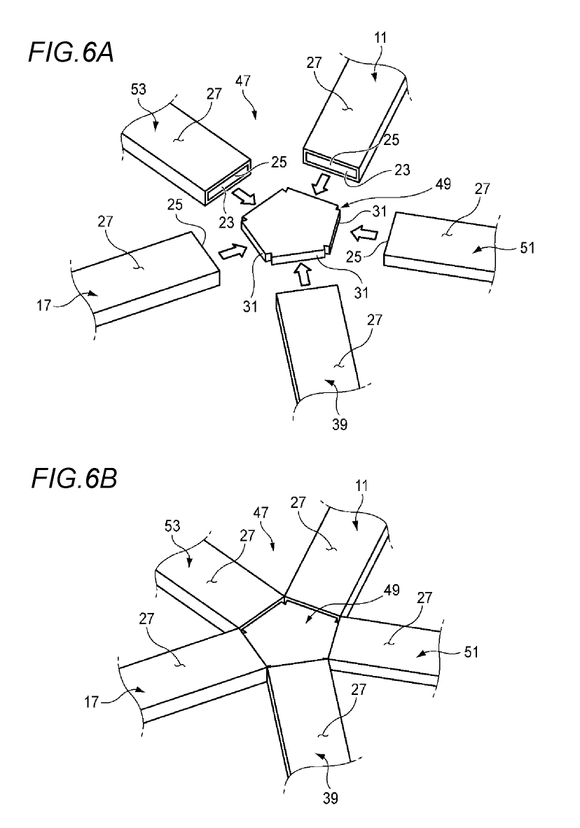

FIG. 6A is an exploded perspective view of a multidirectionally-junction routing body 47 coupled with a conductor connection structure for routing members according to a second embodiment of the present invention, and FIG. 6B is an assembled perspective view of the multidirectionally-junction routing body 47 illustrated in FIG. 6A.

In the conductor connection structure for routing members according to the second embodiment, as illustrated in 6A, the junction member 49 is formed in an approximate pentagonal plate shape. In the junction member 49 of the second embodiment, all sides of a pentagonal shape become junction end face portions 31 (that is, five junction end face portions 31) for metallic bonding.

As illustrated in FIG. 6B, routing members 11, 17, 39, 51 and 53 are metallurgically bonded to the five junction end face portions 31 of the junction member 49. The routing members 11, 17, 39, 51 and 53 are coupled with the junction member 49, and constitute integrally multidirectionally-junction routing body 47.

The shape of the junction member 49 is not limited to the pentagonal shape, and may be a polygonal shape such as a tetragonal shape, a hexagonal shape, or the like. The junction member can also be formed by notching the plurality of junction end face portions 31 including flat surfaces around a circular plate.

According to the conductor connection structure for routing members of the second embodiment, in the plate-like routing members 11, 17, 39, 51 and 53 and the plate-like junction member 49 in which a routing height is suppressed, the plurality of routing members 11, 17, 39, 51 and 53 can be connected in a branching form in an intersecting direction, or be connected in multiple directions, and improve a degree of freedom of a routing design.

### Third Embodiment

Next, a conductor connection structure for routing members according to a third embodiment of the present invention will be described.

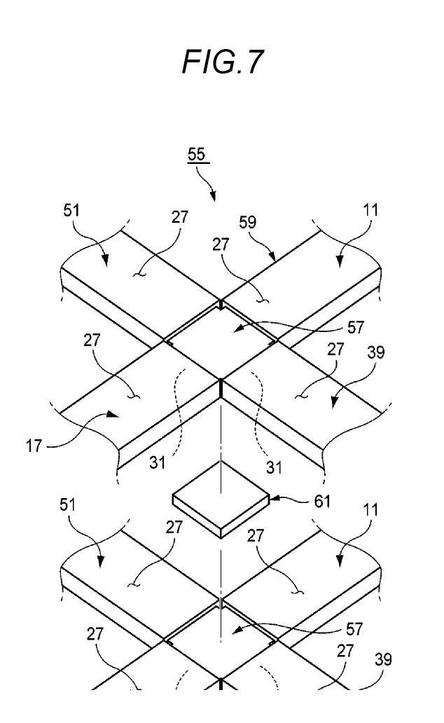

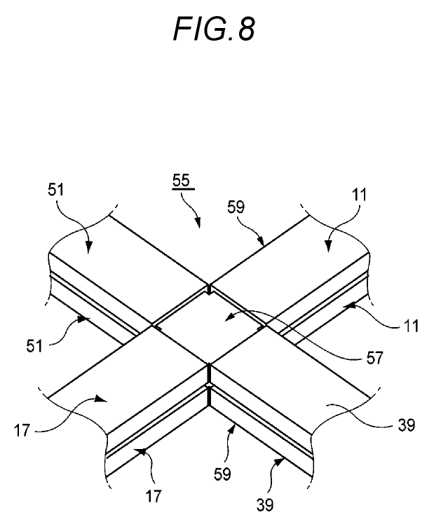

FIG. 7 is an exploded perspective view of a stacked junction routing body 55 formed by a conductor connection structure for routing members according to a third embodiment of the present invention, and FIG. 8 is an assembled perspective view of the stacked junction routing body 55 illustrated in FIG. 7.

In the conductor connection structure for routing members according to the third embodiment, as illustrated in FIG. 7, the junction member 57 is formed in a tetragonal plate shape. In the junction member 57 of the third embodiment, all sides of a tetragonal shape become junction end face portions 31 (that is, four junction end face portions 31) for metallic bonding. Routing members 11, 17, 39 and 51 are metallurgically bonded to the four junction end face portions 31 of the junction member 57.

These routing members 11, 17, 39 and 51 are coupled with the junction member 57, and constitute an integrally junction routing body 59. As illustrated in FIG. 8, two junction routing bodies 59 and 59 are integrated (that is, stacked) in a layered shape.

A boundary between the junction members 57 in the upper layer of junction routing body 59 and the lower layer of junction routing body 59 is electrically insulated by an insulating member 61. The insulating member 61 is formed in a tetragonal plate shape that is substantially the same shape as the junction member 57. Therefore, the two layers of junction routing body 59 in which the junction members 57 are electrically insulated by the insulating member 61 are formed as a stacked junction routing body 55 including two circuits.

According to the conductor connection structure for routing members of the third embodiment, since the two junction routing bodies 59 formed by the plate-like routing members 11, 17, 39 and 51 and the plate-like junction member 57 are stacked to constitute the stacked junction routing body 55, the number of circuits can be multiplied while suppressing a routing height (a height in a plate thickness direction).

Therefore, the conductor connection structure for routing members according to each of the aforementioned embodiments can suppress the number of components and cope with a plurality of branching forms with a saved space while securing dimensional accuracy with easy machining work.

For example, in each of the above embodiments, the case in which the long conductors 23 of the routing members 11, 17, 39, 51 and 53 are of a plate shape has been described by way of example. However, all or some of the long conductors 23 of the plurality of routing members connected to the junction member can also have an energization cross section shaped of, for instance, a circular round bar. In each of the above embodiments, the case in which one fastening piece 35 is provided for each of the junction members 13, 15, and 45 has been described. However, a plurality of fastening pieces 35 may be provided for one junction member.

The present invention is not limited to the above embodiments. It is well expected in the present invention that the components of the embodiments may be mutually combined or the embodiment may be modified or applied by those skilled in the art on the basis of the description of the specification and well-known techniques, and the combinations or the modifications or applications will fall within the scope to be protected.

Here, the aforementioned features of the embodiments of the conductor connection structure for routing members according to the invention are briefly summarized and listed in [1] to [6] below.

[1] A conductor connection structure for routing members comprising:

a routing member (11, 17, 39, 51, 53) in which an outer circumferential surface of a long conductor (23) except conductor end face portions (25) of both ends in a longitudinal direction is coated and insulated; and

a junction member (13, 15, 45, 49, 57) having a plurality of junction end face portions (31) and made of a conductive metal,

wherein one of the junction end face portions (31) are metallurgically bonded to one of the conductor end face portions (25).

[2] The conductor connection structure for routing members according to [1],

wherein the routing member (11, 17, 39, 51, 53) is formed in a plate shape and the junction member (13, 15, 45, 49, 57) is formed in a plate shape.

[3] The conductor connection structure for routing members according to [2],

wherein a fastening piece (35) in which a bolt fastening hole (33) is drilled is projected from at least one of the junction end face portions (31) of the junction member (13, 15, 45).

[4] The conductor connection structure for routing members according to [3],

wherein the fastening piece (35) is projected from each of a plurality of the junction members (13 and 15), and

wherein the plurality of the junction members (13 and 15) are bolt-nut fastened at the fastening pieces (35).

[5] The conductor connection structure for routing members according to [2],

wherein the junction member (13, 15, 45, 49, 57) is formed in a polygonal plate shape.

[6] The conductor connection structure for routing members according to [5],

wherein a junction routing body (59) in which the conductor end face portions (25) of a plurality of the routing members (11, 17, 39, and 51) are respectively metallurgically bonded to a plurality of the junction end face portions (31) of the junction member (57) is formed, and

wherein a stacked junction routing body (55) in which a plurality of the junction routing bodies (59) are stacked is formed.
11 Routing member
13 Junction member
15 Junction member
17 Routing member
19 Bolt
21 Nut
23 Long conductor
25 Conductor end face portion
29 Junction routing body
31 Junction end face portion
33 Bolt fastening hole
35 Fastening piece
39 Routing member

What is claimed is:

1. A conductor connection structure for routing members comprising:
a routing member in which an outer circumferential surface of a long conductor except conductor end face portions of both ends in a longitudinal direction is coated and insulated; and
a junction member having a plurality of junction end face portions and made of a conductive metal,
wherein one of the junction end face portions is metallurgically bonded to one of the conductor end face portions.

2. The conductor connection structure for routing members according to claim 1,
wherein the routing member is formed in a plate shape and the junction member is formed in a plate shape.

3. The conductor connection structure for routing members according to claim 2,
wherein a fastening piece in which a bolt fastening hole is drilled is projected from at least one of the junction end face portions of the junction member.

4. The conductor connection structure for routing members according to claim 3,
wherein the fastening piece is projected from each of a plurality of the junction members, and
wherein the plurality of the junction members are bolt-nut fastened at the fastening pieces.

5. The conductor connection structure for routing members according to claim 2,
wherein the junction member is formed in a polygonal plate shape.

6. The conductor connection structure for routing members according to claim 5,
wherein a junction routing body in which the conductor end face portions of a plurality of the routing members are respectively metallurgically bonded to a plurality of the junction end face portions of the junction member is formed, and
wherein a stacked junction routing body in which a plurality of the junction routing bodies are stacked is formed.
